(19) United States
(12) Patent Application Publication
(10) Pub. No.: US 2026/0099717 A1
(43) Pub. Date: Apr. 9, 2026

(54) SYSTEM AND METHOD FOR AUTONOMOUS WEBSITE APPLICATION INTERACTIONS USING HTML COMPONENT DENOISING

(71) Applicant: Tricentis GmbH, Vienna (AT)

(72) Inventors: David COLWELL, Surry Hills (AU); Marius VIKTOR, Melbourne (AU); Mark BUGNO, Sydney (AU); Venkata BOMMIREDDIPALLI, New South Wales (AU); Michael KEELEY, Aukland (NZ)

(21) Appl. No.: 18/907,025

(22) Filed: Oct. 4, 2024

(51) Int. Cl. G06N 3/0895

(52) U.S. Cl. CPC G06N 3/0895

(57) ABSTRACT

Systems adapted to denoise HTML components of a website application and execute a task, using a trained generative artificial intelligence (AI) service comprising at least one trained multimodal machine learning model and at least one trained large language model (LLM), include receiving a request associated with executing the task using the website application, wherein executing the task comprises executing a series of steps; wherein executing the series of steps comprises identifying and using one or more target website application elements corresponding with the series of steps; processing, via the model, the website application to identify a plurality of HTML components of the website application; generating, via the model, a website application structure using the identified plurality of HTML components; and executing the task using the generated website application structure to execute the series of steps by identifying and using the one or more target website application elements.

### TECHNICAL FIELD

The present disclosure relates generally to methods and systems of HTML component denoising, and more specifically relates to methods and systems for HTML component denoising with respect to a website application, in order to execute a request associated with executing a task using the website application.

### BACKGROUND

The subject matter discussed in this background section should not be assumed to be prior art merely as a result of its mention herein. Similarly, a problem mentioned in this background section or associated with the subject matter of the background section should not be assumed to have been previously recognized (or be conventional or well-known) in the prior art. The subject matter in this background section merely represents different approaches, which in and of themselves may also be inventions.

Large language models (LLMs) are a type of generative artificial intelligence (generative AI). LLMs perform by generating new outputs or by completing language-based tasks, through natural language processing. LLMs receive various inputs related to the outputs and/or tasks they are being requested to perform, typically consisting of textual contexts, such as, for example, various documents, website applications, etc. Textual contexts may be measured in units called “tokens.” More complicated textual contexts, such as website applications for online shopping websites, may contain hundreds of thousands of tokens. In current methods, LLMs may need to process all tokens of the contexts they have received as input, in order to perform as directed. As such, currently available LLMs are subject to token limits when processing website applications, as many website applications may measure at hundreds of thousands of tokens in terms of textual context. These token limits may be expanded, however, such expansions increase the cost of processing requests relating to the website application, increase the time required to process actions, and in some cases, expanding the token limit may be impossible

Autonomous web agents, e.g., LLMs, are able to autonomously navigate website applications in order to execute certain requests and tasks received as a conversational input from a user. These LLMs need to be able to process large amounts of tokens in order to identify parts of the website application, as well as the actions needed to execute the task. A problem faced by current autonomous agents when interacting with website applications is that the website application pages can get quite large in terms of token length (e.g., larger than 500,000 tokens). Many models cannot fit (e.g., ingest or process) this token length due to hardware and cost limitations, and further, accuracy in detail degrades with increased context length, especially as the model tries to process information in the center of the context, where the bulk of the HTML is located.

Current methods involve training specific LLMs to summarize a website and its textual context; however, these methods are still subject to the context length limitations and issues discussed above, and result in cost and time restraints. Accordingly, what is needed is a system that denoises the HTML tokens of a website application, such that an LLM would not need to process parts of the website that are not relevant to a website summarization task.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified data flow in a system according to various aspects of the present disclosure.

FIG. 2 is a flowchart of a method of for denoising HTML components of a website application, according to embodiments of the present disclosure.

FIG. 3A illustrates an exemplary schematic of a website application, according to embodiments of the present disclosure. FIG. 3B illustrates an exemplary schematic showing a website application structure generated for the website application illustrated in FIG. 3A, according to embodiments of the present disclosure.

FIG. 4 is a graph showing reduction in the number of tokens of various website applications, according to embodiments of the present disclosure.

FIG. 5 is a simplified data flow for training a generative artificial intelligence (AI) service in a system according to embodiment of the present disclosure.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

The systems and methods described herein relate to HTML component denoising with respect to a website application to more efficiently execute a request associated with executing a task using the website application. In various embodiments, HTML components of a website application are denoised and a task is executed, using a trained generative artificial intelligence (AI) service comprising at least one trained multimodal machine learning model and at least one trained large language model (LLM). A request associated with executing the task using the website application is received at the LLM, wherein executing the task comprises executing a series of steps, and wherein executing the series of steps comprises identifying and using one or more target website application elements corresponding with the series of steps. The website application is processed via the multimodal machine learning model, to identify a plurality of HTML components of the website application. A website application structure is generated using the identified plurality of HTML components, via the multimodal machine learning model. The task is executed via the LLM, using the generated website application structure to execute the series of steps by identifying and using the one or more target website application elements.

In certain embodiments, processing the website application to identify a plurality of HTML components of the website application includes identifying a plurality of website application elements of the website application, wherein the plurality of website application elements comprises HTML elements, visual elements, or a combination thereof, and identifying a plurality of HTML components corresponding to the plurality of website application elements.

In some embodiments, identifying a plurality of HTML components corresponding to the plurality of website application elements further comprises identifying parent HTML components and child HTML components of the plurality of HTML components by analyzing at least one of: change in visual area assigned to at least two website application elements, tree-size of a website application element, visual area attributable to a website application element, a presence of a similar parent or child website application element, and cross-page occurrence of a parent or child website application element.

In several embodiments, generating a website application structure includes forming one or more family hierarchies based on parent HTML components and child HTML components of the identified plurality of HTML components, grouping similar HTML components of the identified plurality of HTML components into one or more clusters, and generating a label for the one or more family hierarchies, for the one or more clusters, and for each singleton HTML component of a plurality of singleton HTML components. In various embodiments, the label comprises a description of the family hierarchy, the cluster, or the singleton HTML component.

In certain embodiments, grouping similar HTML components into one or more clusters comprises identifying similarity between at least two identified HTML components, wherein similarity may be identified using: visual embedding, weighted property distancing, text content distancing, parent and child website application element distancing, tag distancing, shape distancing, structural similarity, parent website application element similarity, child website application element similarity, or a combination thereof. In several embodiments, identifying similarity between HTML components using visual embedding further comprises visually pre-tagging corresponding website application elements.

In some embodiments, the identified plurality of HTML components and the generated website application structure of a first page of the website application may be used to preprocess a successive page of the website application.

In one or more embodiments, the system may include at least one processor and a non-transitory computer readable storage medium containing instructions which, when executed on the one or more data processors, cause the one or more data processors to perform any of the methods disclosed herein. In one or more embodiments, a computer-program product tangibly embodied in a non-transitory machine-readable storage medium, including instructions configured to cause one or more data processors to perform any of the methods disclosed herein, is provided.

The embodiments described herein improve one or more technical fields, such as for example the technical field of autonomous web agents executing a task on a website application, related to a conversational request. For example, the embodiments described herein improve the technical field of autonomous web agents executing a task on a website application by generating a website application structure, such that only the tokens of the website application that are relevant to the task can be processed by the autonomous web agent, thereby denoising the website application and allowing the autonomous web agent to more efficiently execute the task as requested. This example improvement is due to the described embodiments providing a technical solution (denoising the HTML components of a website application by generating a labeled website application structure) to a technical problem (limitations on the context length (e.g., token limits) that can be input into currently available autonomous web agents (e.g., LLMs)).

In some embodiments, the embodiments described herein provide include an unconventional combination of steps that results in improvements to the technical field of autonomous web agents executing a task on a website application related to a conversational request. For example, the combination of steps associated with training the generative AI service using training data that includes website applications, corresponding website application structures, and target website application elements corresponding to a task, is associated with identification and selection of website application elements that is more efficient, more accurate, and in some cases, indicative of the usability of a website application, in executing a task on the website application.

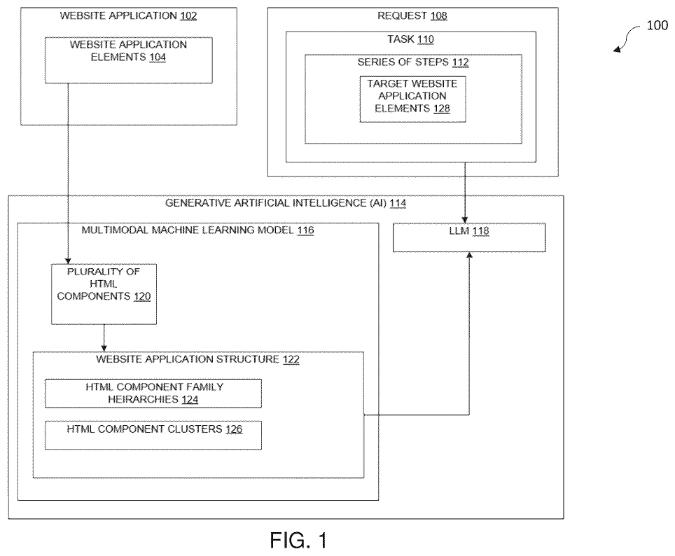

FIG. 1 illustrates execution of a task in an example website interaction system 100 according to some embodiments of the present disclosure. As shown, website interaction system 100 may include or implement a plurality of devices, servers, and/or software components that operate to perform various methodologies in accordance with the described embodiments. Exemplary devices and servers may include device, stand-alone, and enterprise-class servers, operating an operating system (OS) such as a MICROSOFT® OS, a UNIX® OS, a LINUX® OS, or another suitable device and/or server-based OS. It will be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, machine learning (ML), neural network (NN), and other artificial intelligence (AI) architectures have been developed to improve predictive analysis and classifications by systems in a manner similar to human decision-making, which increases efficiency and speed in performing predictive analysis of transaction data sets. One or more devices and/or servers may be operated and/or maintained by the same or different entities.

As shown, website interaction system 100 includes website application 102, request 108, and generative artificial intelligence (AI) 114. In one or more embodiments, website application 102 is a website accessible through the Internet that may be used to execute a task, such as, for example but not limited to, an airline website to book flight travel, a car rental website to book a rental car, a doctor's office website to book an appointment, an online store to shop for products to be delivered to one's home, etc. Website application 102 includes various website application elements 104, which are used for task execution or to provide additional information to a user or visitor of website application 102. For instance, using one of the non-limiting examples above of the airline website, a user may book flight travel by using various website application elements 104 of the airline website, such as drop down menus, entry fields, selection buttons, etc., allowing the user to select travel dates, the airport of origin as well as the destination airport, select a number of tickets to be purchased, etc. Website application elements 104 may be HTML elements, visual elements, or a combination thereof.

In one or more embodiments, request 108 is associated with execution of task 110 using website application 102. Task 110 includes executing series of steps 112 (also referred to as “steps 112” herein). Execution of steps 112 includes identifying and using one or more target elements of the website application (e.g., target website application elements 128) corresponding with steps 112 required for execution of task 110. As a non-limiting example, execution of booking flight tickets as task 110 requires at least selection of travel dates, origin and destination airports, and specifying passenger count as steps 112. Execution of those steps 112 would require identifying website application elements including drop down menus, entry fields, selection buttons, etc. allowing for selection of travel dates, origin and destination airports, and specifying passenger count as target website application elements 128 of an airline website as website application 102.

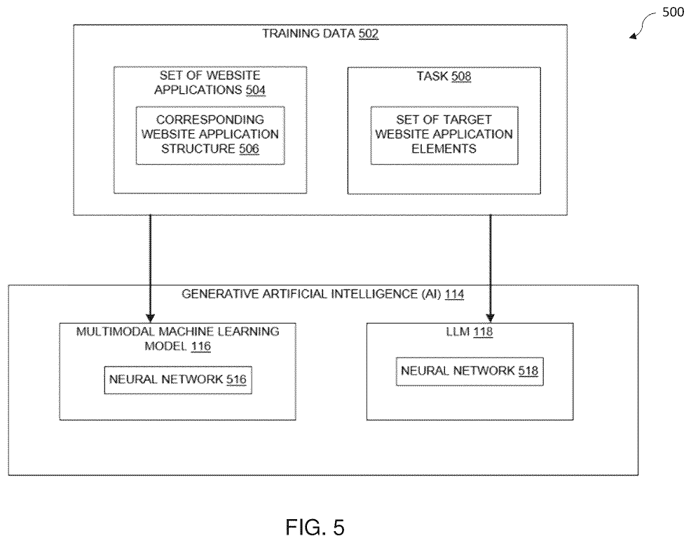

In various embodiments, generative AI 114 includes at least one multimodal machine learning model (e.g., multimodal machine learning model 116) and at least one large language model (LLM) (e.g., LLM 118). The training of generative AI 114 is discussed further with respect to FIG. 5 below.

Multimodal machine learning model 116 may include one or more clustering algorithms and operations, decision trees and corresponding branches, neural networks, LLMs, convolutional neural networks, etc. Multimodal machine learning model 116 may be trained using training data, which may contain data corresponding to stored, preprocessed, and/or feature transformed data associated with processing website applications for HTML component denoising. LLM 118 may include one or more large language models trained to autonomously navigate an unspecified number of website applications. LLM 118 may be used by, for example without limitation, assistants such as Alexa® and Siri® to complete tasks for users without needing specific API integrations. LLM 118 may additionally be used to test website applications for accessibility to disabled and/or impaired populations and overall user-friendliness. In some embodiments, LLM 118 may include Azure Open AI, Google Bard, etc., although other and/or proprietary LLMs may be used.

The general data flow through the website interaction system 100 is as follows in the exemplary embodiment described below: a request 108 associated with the execution of task 110 using website application 102 is received by LLM 118. Execution of task 110 includes execution of a series of steps 112, which involves identifying and optionally selecting one or more target website application elements 128 corresponding with series of steps 112.

Multimodal machine learning model 116 processes website application 102 by identifying a plurality of HTML components 120 corresponding to the plurality of website application elements 104 of website application 102. Multimodal machine learning model 116 generates website application structure 122, which organizes the plurality of HTML components 120 to include one or more HTML component family hierarchies 124 and one or more HTML component clusters 126.

LLM 118 then uses the generated website application structure 122 to select and use target website application elements 128, in order to execute the series of steps 112 necessary for execution of task 110, per request 108. By using generated website application structure 122 to select and use only the target website application elements 128, LLM 118 does not have to unnecessarily process tokens associated with non-target website application elements, effectively denoising the HTML components of website application 104 to efficiently execute task 110.

In various embodiments, multimodal machine learning model 116 processes website application 102 by identifying website application elements 104 of the website application 102. Website application elements 104 may include HTML elements, visual elements, or a combination thereof. Next, multimodal machine learning model 116 identifies plurality of HTML components 120 corresponding to website application elements 104, including identifying parent HTML components and child HTML components by analyzing at least one of: change in visual area assigned to at least two website application elements, tree-size of a website application element, visual area attributable to a website application element, a presence of a similar parent or child website application element, and cross-page occurrence of a parent or child website application element.

In some embodiments, multimodal machine learning model 116 generates website application structure 122 by forming one or more HTML component family hierarchies 124, based on parent HTML components and child HTML components of the identified plurality of HTML components 120, grouping similar HTML components of the identified plurality of HTML components 120 into one or more HTML component clusters 126. Grouping similar HTML components into one or more HTML component clusters 126 includes identifying similarity between at least two identified HTML components of plurality of HTML components 120, and similarity may be identified using visual embedding, weighted property distancing, text content distancing, parent and child website application element distancing, tag distancing, shape distancing, structural similarity, parent website application element similarity, child website application element similarity, or a combination thereof. Identifying similarity between two or more HTML components using visual embedding may include visually pre-tagging corresponding website application elements.

The one or more HTML component family hierarchies 124, one or more HTML component clusters 126, and any singleton HTML components (e.g., any HTML components identified in plurality of HTML components 120 but not included in a family hierarchy or cluster) are then labeled with a description of the family hierarchy, the cluster, or the singleton HTML component. In various embodiments, the description may be used by LLM 118 to select and use target website application elements 128, thereby reducing, or denoising, the number of tokens needed to be processed by LLM to execute task 110 per request 108.

In some embodiments, website application 102 may include multiple web pages, such as but not limited to, a first page, a second page, a third page etc. In such embodiments, identified plurality of HTML components 120 and/or the generated website application structure 122 of a first page of website application 102 may be used to preprocess a successive page of website application structure 102.

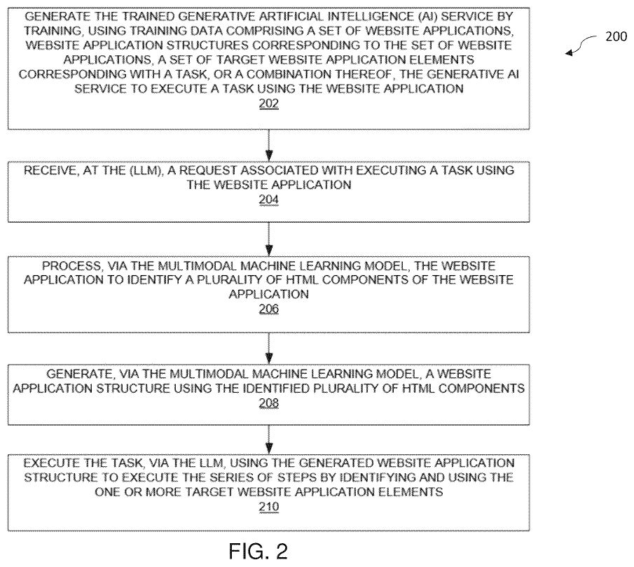

FIG. 2 is an exemplary flowchart 200 for website application interaction, including denoising of HTML components of a website application, according to embodiments of the present disclosure. Note that one or more steps, processes, and methods described herein of flowchart 200 may be omitted, performed in a different sequence, or combined as desired or appropriate based on the guidance provided herein. Flowchart 200 of FIG. 2 includes operations for website application interaction, as discussed in reference to FIG. 1. One or more of steps 202-210 of flowchart 200 may be implemented, at least in part, in the form of executable code stored on non-transitory, tangible, machine-readable media that when run by one or more processors may cause the one or more processors to perform one or more of steps 202-208. In some embodiments, flowchart 200 can be performed by one or more computing devices discussed in website interaction system 100 of FIG. 1.

Accordingly, at step 202 of flowchart 200, website interaction system 100 generates a trained generative artificial intelligence (AI) service (e.g., generative AI 114) by training, using training data comprising a set of website applications, website application structures corresponding to the set of website applications, a set of target website application elements corresponding with a task, or a combination thereof, the generative AI service to execute a task (e.g., task 110) using the website application. The training of generative AI service 114 is discussed further in FIG. 5 below.

At step 204 of flowchart 200, website interaction system 100, receives, at large language model (LLM) 118, request 108 associated with executing task 110 using a website application 102. In one or more embodiments, executing task 110 includes executing series of steps 112, which includes identifying and using target website application elements 128 corresponding with the series of steps.

In one or more embodiments, website application 102 includes various website application elements 104, which are used for task execution or to provide additional information to a user or visitor of website application 102. Website application elements 104 may be HTML elements, visual elements, or a combination thereof. In various embodiments, request 108 is associated with execution of task 110 using website application 102. Task 110 includes executing series of steps 112 (also referred to as “steps 112” herein). Execution of steps 112 includes identifying and using one or more target elements of the website application (e.g., target website application elements 128) corresponding with steps 112 required for execution of task 110. As a non-limiting example, execution of booking flight tickets as task 110 requires at least selection of travel dates, origin and destination airports, and specifying passenger count as steps 112. Execution of those steps 112 would require identifying website application elements including drop down menus, entry fields, selection buttons, etc. allowing for selection of travel dates, origin and destination airports, and specifying passenger count as target website application elements 128 of an airline website as website application 102.

At step 206 of flowchart 200, website application 102 is processed via multimodal machine learning model 116, to identify plurality of HTML components 120 of the website application.

In various embodiments, multimodal machine learning model 116 processes website application 102 by identifying website application elements 104 of the website application 102. Website application elements 104 may include HTML elements, visual elements, or a combination thereof. Next, multimodal machine learning model 116 identifies plurality of HTML components 120 corresponding to website application elements 104, including identifying parent HTML components and child HTML components.

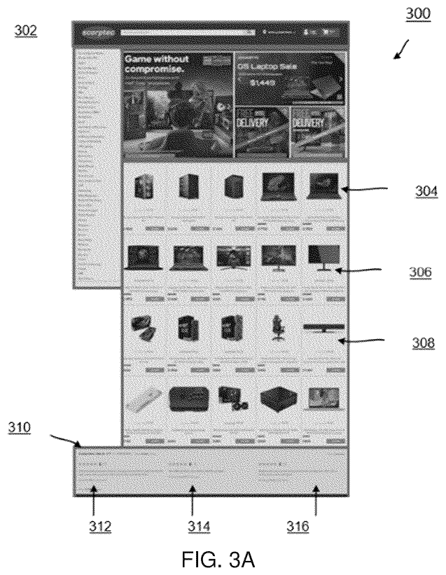

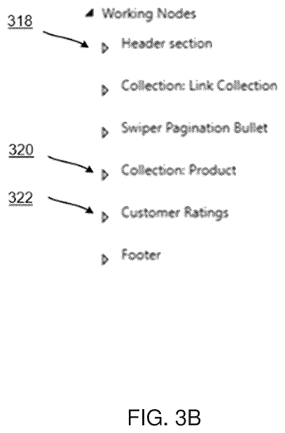

FIG. 3A is an exemplary schematic showing how a website application 300 (e.g., website application 102) may be processed to identify a plurality of website application elements 104. As a non-limiting example, elements 302-316 are website application elements that may be used to interact with and to use website application 300. Element 310 (i.e., the customer ratings header) would correspond to a parent HTML component, with elements 312, 314, and 316 (i.e., the ratings themselves) corresponding to associated child HTML components.

At step 208 of flowchart 200, website application structure 122 may be generated via multimodal machine learning model 116, using the identified plurality of HTML components 120.

In one or more embodiments, multimodal machine learning model 116 generates website application structure 122 by forming one or more HTML component family hierarchies 124, based on parent HTML components and child HTML components of the identified plurality of HTML components 120, grouping similar HTML components of the identified plurality of HTML components 120 into one or more HTML component clusters 126. The one or more HTML component family hierarchies 124, one or more HTML component clusters 126, and any singleton HTML components (e.g., any HTML components identified in plurality of HTML components 120 but not included in a family hierarchy or cluster) are then labeled with a description of the family hierarchy, the cluster, or the singleton HTML component. In various embodiments, the description may be used by LLM 118 to select and use target website application elements 128, thereby reducing, or denoising, the number of tokens needed to be processed by LLM to execute task 110 per request 108.

FIG. 3B is an exemplary schematic showing a corresponding website application structure 122 that may be generated for the website application 300 as shown in FIG. 3A. The singleton HTML component 318 labeled “Header Section” corresponds with the HTML component corresponding with element 302. The HTML component cluster 320 labeled “Collection: Product” corresponds with the similar HTML components corresponding to elements 304, 306, and 308, each of which are products sold through the website application 300. The HTML component family hierarchy 322 labeled “Customer Ratings” corresponds with the parent HTML component corresponding to element 310, as well as child HTML components corresponding to elements 312, 314, and 316.

At step 210 of flowchart 200, task 104 is executed via LLM 118, using the generated website application structure 122 to execute series of steps 112 by identifying and using one or more target website application elements 128.

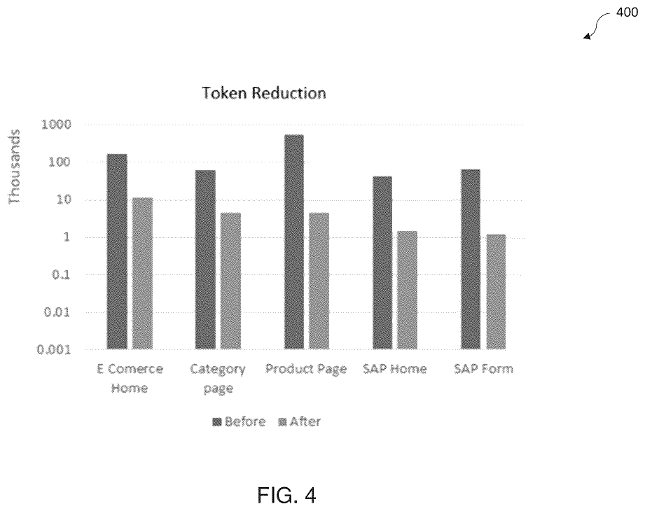

FIG. 4 is a graph 400 showing how the number of tokens is reduced by using the embodiments as described herein. The results in FIG. 4 show a reduction in the context length (i.e., a reduction in the number of tokens) of various website applications as input into an LLM (e.g., LLM 118). Reducing the context length of the website applications allows LLM 118 to process fewer tokens when executing a task. The percentage of reduction of context length may vary based on features relating to the website application.

FIG. 5 illustrates training of the generative artificial intelligence (AI) service (e.g., generative AI service 114 in FIG. 1) in a training mode of an example website interaction system 500, according to some embodiments of the present disclosure. Generative AI service 114, when in training mode, receives training data 502 from system 100. In one or more embodiments, training data 502 includes a set of website applications, website application structures corresponding to the set of website applications, a set of target website application elements corresponding with a task, or a combination thereof. In some embodiments, the set of target website application elements correspond with a task that may be executed using a website application and its corresponding website application structure.

In one or more embodiments, generative AI service 114 includes at least one multimodal machine learning model (e.g., multimodal machine learning model 116) and at least one large language model (LLM) (e.g., LLM 118). Multimodal machine learning model 116 and LLM 118 may each include at least one neural network (e.g., neural networks 506 and 508). Neural networks such as neural networks 506 and 508 allow generative AI service 114 to learn how to execute a request associated with executing a task using a website application, by learning how to denoise the HTML tokens of a website application, such that generative AI service 114 only has to process the HTML tokens associated with the target website application elements (e.g., target website application elements 128) in order to execute the task.

In some embodiments, neural networks 516 and/or 518 may comprise one or more nodes, that are each weighted according to what the neural network has learned is important in generating the correct output, based on training data 502. For example, multimodal machine learning model 116 may modify one or more weights of one or more nodes in neural network 516 as it learns from training data 502 how to identify a plurality of HTML components corresponding to a plurality of website application elements of a website application. Multimodal machine learning model 116 may additionally modify one or more weights of one or more nodes in neural network 516 as it learns from training data 502 how to generate a website application structure corresponding to the website application, using the plurality of identified HTML components.

As an additional example, LLM 118 may modify one or more weights of one or more nodes in neural network 518 as it learns from training data 502 how to use the website application structure corresponding with a website application in order to execute a task using the website application. LLM 118 may additionally modify one or more weights of one or more nodes in neural network 518 as it learns from training data 502 how to execute a task using a website application by processing as few HTML tokens as possible, using the website application structure to process only those tokens associated with target website application elements 128.

### Example Definitions and Context

The disclosure is not limited to these example embodiments and applications or to the manner in which the example embodiments and applications operate or are described herein. Moreover, the figures may show simplified or partial views, and the dimensions of elements in the figures may be exaggerated or otherwise not in proportion.

Where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular.

Where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

As used herein, the term “denoise” means to reduce, and in one preferred embodiment to eliminate, noise in terms of tokens or HTML components associated with a website application where such tokens or HTML components are not necessary for execution of a task as requested in connection with use of the website application (e.g., target website application elements). The term can also include preventing or avoiding an increase in noise of such tokens or HTML components.

As used herein, the term “plurality” can be 2, 3, 4, 5, 6, 7, 8, 9, 10, or more.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required. For example, without limitation, “at least one of item A, item B, or item C” means item A; item A and item B; item B; item A, item B, and item C; item B and item C; or item A and C. In some cases, “at least one of item A, item B, or item C” means, but is not limited to, two of item A, one of item B, and ten of item C; four of item B and seven of item C; or any other suitable combination.

As used herein, a “model” may include one or more algorithms, one or more mathematical techniques, one or more machine learning (ML) algorithms, or a combination thereof.

As used herein, “machine learning” may include the practice of using algorithms to parse data, learn from it, and then make a determination or prediction about something in the world. Machine learning uses algorithms that can learn from data without relying on rules-based programming.

As used herein, an “artificial neural network” or “neural network” may refer to mathematical algorithms or computational models that mimic an interconnected group of artificial neurons that processes information based on a connectionistic approach to computation. Neural networks, which may also be referred to as neural nets, can employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters. In the various embodiments, a reference to a “neural network” may be a reference to one or more neural networks.

A neural network may process information in, for example, two ways; when it is being trained (e.g., using a training dataset) it is in training mode and when it puts what it has learned into practice (e.g., using a test dataset) it is in inference (or prediction) mode. Neural networks may learn through a feedback process (e.g., backpropagation) which allows the network to adjust the weight factors (modifying its behavior) of the individual nodes in the intermediate hidden layers so that the output matches the outputs of the training data. In other words, a neural network may learn by being fed training data (learning examples) and eventually learns how to reach the correct output, even when it is presented with a new range or set of inputs.

A neural network may process information in two ways; when it is being trained it is in training mode and when it puts what it has learned into practice it is in inference (or prediction) mode. Neural networks learn through a feedback process (e.g., backpropagation) which allows the network to adjust the weight factors (modifying its behavior) of the individual nodes in the intermediate hidden layers so that the output matches the outputs of the training data. In other words, a neural network learns by being fed training data (learning examples) and eventually learns how to reach the correct output, even when it is presented with a new range or set of inputs. A neural network may include, for example, without limitation, at least one of a Feedforward Neural Network (FNN), a Recurrent Neural Network (RNN), a Modular Neural Network (MNN), a Convolutional Neural Network (CNN), a Graph Convolutional Network (GCN), a Residual Neural Network (ResNet), an Ordinary Differential Equations Neural Networks (neural-ODE), or another type of neural network.

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the spirit and full scope of the embodiments disclosed herein.

The Abstract at the end of this disclosure is provided to comply with 37 C.F.R. § 1.72(b) to allow a quick determination of the nature of the technical disclosure. It is submitted with the understanding that it will not be used to interpret or limit the scope or meaning of the claims.

What is claimed is:

1. A website application interaction system configured to denoise HTML components of a website application and execute a task, using a trained generative artificial intelligence (AI) service comprising at least one trained multimodal machine learning model and at least one trained large language model (LLM), the website application interaction system comprising:
a processor and a non-transitory computer readable medium operably coupled thereto, the computer readable medium comprising a plurality of instructions stored in association therewith that are accessible to, and executable by, the processor, to perform HTML denoising operations which comprise:
generating the trained generative AI service by training, using training data comprising a set of website applications, website application structures corresponding to the set of website applications, a set of target website application elements corresponding with a task, or a combination thereof, the generative AI service to execute a task using the website application, wherein training the generative AI service comprises modifying one or more weights of one or more nodes of an artificial neural network;
receiving, at the LLM, a request associated with executing the task using the website application,
wherein executing the task comprises executing a series of steps; and
wherein executing the series of steps comprises identifying and using one or more
target website application elements corresponding with the series of steps;
processing, via the multimodal machine learning model, the website application to identify a plurality of HTML components of the website application;
generating, via the multimodal machine learning model, a website application structure using the identified plurality of HTML components; and
executing the task, via the LLM, using the generated website application structure to execute the series of steps by identifying and using the one or more target website application elements.

2. The system of claim 1, wherein processing the website application to identify a plurality of HTML components of the website application comprises:
identifying a plurality of website application elements of the website application, wherein the plurality of website application elements comprises HTML elements, visual elements, or a combination thereof; and
identifying a plurality of HTML components corresponding to the plurality of website application elements.

3. The system of claim 2, wherein identifying a plurality of HTML components corresponding to the plurality of website application elements further comprises identifying parent HTML components and child HTML components of the plurality of HTML components by analyzing at least one of: change in visual area assigned to at least two website application elements, tree-size of a website application element, visual area attributable to a website application element, a presence of a similar parent or child website application element, and cross-page occurrence of a parent or child website application element.

4. The system of claim 1, wherein generating a website application structure comprises:
forming one or more family hierarchies based on parent HTML components and child HTML components of the identified plurality of HTML components;
grouping similar HTML components of the identified plurality of HTML components into one or more clusters; and
generating a label for the one or more family hierarchies, for the one or more clusters, and for each singleton HTML component of a plurality of singleton HTML components.

5. The system of claim 4, wherein the label comprises a description of the family hierarchy, the cluster, or the singleton HTML component.

6. The system of claim 4, wherein grouping similar HTML components into one or more clusters comprises identifying similarity between at least two identified HTML components, wherein similarity may be identified using: visual embedding, weighted property distancing, text content distancing, parent and child website application element distancing, tag distancing, shape distancing, structural similarity, parent website application element similarity, child website application element similarity, or a combination thereof.

7. The system of claim 6, wherein identifying similarity between HTML components using visual embedding further comprises visually pre-tagging corresponding website application elements.

8. The system of claim 1, further comprising using the identified plurality of HTML components and the generated website application structure of a first page of the website application to preprocess a successive page of the website application.

9. A method to denoise HTML components of a website application and execute a task, using a trained generative artificial intelligence (AI) service comprising at least one trained multimodal machine learning model and at least one trained large language model (LLM), the method comprising:
generating the trained generative AI service by training, using training data comprising a set of website applications, website application structures corresponding to the set of website applications, a set of target website application elements corresponding with a task, or a combination thereof, the generative AI service to execute a task using the website application, wherein training the generative AI service comprises modifying one or more weights of one or more nodes of an artificial neural network;
receiving, at the LLM, a request associated with executing the task using the website application,
wherein executing the task comprises executing a series of steps; and
wherein executing the series of steps comprises identifying and using one or more
target website application elements corresponding with the series of steps;
processing, via the multimodal machine learning model, the website application to identify a plurality of HTML components of the website application;
generating, via the multimodal machine learning model, a website application structure using the identified plurality of HTML components; and
executing the task, via the LLM, using the generated website application structure to execute the series of steps by identifying and using the one or more target website application elements.

10. The method of claim 9, wherein processing the website application to identify a plurality of HTML components of the website application comprises:
identifying a plurality of website application elements of the website application, wherein the plurality of website application elements comprises HTML elements, visual elements, or a combination thereof; and
identifying a plurality of HTML components corresponding to the plurality of website application elements.

11. The method of claim 10, wherein identifying a plurality of HTML components corresponding to the plurality of website application elements further comprises identifying parent HTML components and child HTML components of the plurality of HTML components by analyzing at least one of: change in visual area assigned to at least two website application elements, tree-size of a website application element, visual area attributable to a website application element, a presence of a similar parent or child website application element, and cross-page occurrence of a parent or child website application element.

12. The method of claim 9, wherein generating a website application structure comprises:
forming one or more family hierarchies based on parent HTML components and child HTML components of the identified plurality of HTML components;
grouping similar HTML components of the identified plurality of HTML components into one or more clusters; and
generating a label for the one or more family hierarchies, for the one or more clusters, and for each singleton HTML component of a plurality of singleton HTML components.

13. The method of claim 12, wherein the label comprises a description of the family hierarchy, the cluster, or the singleton HTML component.

14. The method of claim 12, wherein grouping similar HTML components into one or more clusters comprises identifying similarity between at least two identified HTML components, wherein similarity may be identified using: visual embedding, weighted property distancing, text content distancing, parent and child website application element distancing, tag distancing, shape distancing, structural similarity, parent website application element similarity, child website application element similarity, or a combination thereof.

15. The method of claim 14, wherein identifying similarity between HTML components using visual embedding further comprises visually pre-tagging corresponding website application elements.

16. The method of claim 9, further comprising using the identified plurality of HTML components and the generated website application structure of a first page of the website application to preprocess a successive page of the website application.

17. A non-transitory computer-readable medium having stored thereon computer-readable instructions executable to denoise HTML components of a website application and execute a task, using a trained generative artificial intelligence (AI) service comprising at least one trained multimodal machine learning model and at least one trained large language model (LLM), the instructions executable by at least one processor to perform operations which comprise:
generating the trained generative AI service by training, using training data comprising a set of website applications, website application structures corresponding to the set of website applications, a set of target website application elements corresponding with a task, or a combination thereof, the generative AI service to execute a task using the website application, wherein training the generative AI service comprises modifying one or more weights of one or more nodes of an artificial neural network;
receiving, at the LLM, a request associated with executing the task using the website application,
wherein executing the task comprises executing a series of steps; and
wherein executing the series of steps comprises identifying and using one or more
target website application elements corresponding with the series of steps;
processing, via the multimodal machine learning model, the website application to identify a plurality of HTML components of the website application;
generating, via the multimodal machine learning model, a website application structure using the identified plurality of HTML components; and
executing the task, via the LLM, using the generated website application structure to execute the series of steps by identifying and using the one or more target website application elements.

18. The non-transitory computer-readable medium of claim 17, wherein processing the website application to identify a plurality of HTML components of the website application comprises:
identifying a plurality of website application elements of the website application, wherein the plurality of website application elements comprises HTML elements, visual elements, or a combination thereof; and
identifying a plurality of HTML components corresponding to the plurality of website application elements.

19. The non-transitory computer-readable medium of claim 17, wherein generating a website application structure comprises:
forming one or more family hierarchies based on parent HTML components and child HTML components of the identified plurality of HTML components; and
grouping similar HTML components of the identified plurality of HTML components into one or more clusters; and
generating a label for the one or more family hierarchies, for the one or more clusters, and for each singleton HTML component of a plurality of singleton HTML components.

20. The non-transitory computer-readable medium of claim 19, wherein the label comprises a description of the family hierarchy, the cluster, or the singleton HTML component.
